(19) United States
(12) Patent Application Publication
(10) Pub. No.: US 2003/0135375 A1
(43) Pub. Date: Jul. 17, 2003

(54) Encoding speech segments for economical transmission and automatic playing at remote computers

(76) Inventor: Richard W. Bloomstein, Highland Park, IL (US)

Correspondence Address: RICHARD W. BLOOMSTEIN, 1443 CAVELL STREET, HIGHLAND PARK, IL, 60035-2807, US

(21) Appl. No.: 09/683,524

(22) Filed: Jan. 14, 2002

(51) Int. Cl. G10L 21/00

(52) U.S. Cl. 704/270

(57) ABSTRACT

The present invention provides methods for encoding speech segments in a manner in which they can be transmitted as compressed digital signals accompanying a document and decompressed and played automatically at remote computers without pre-arrangement, direct intervention such as a mouse click or apparent delay in interactive networks such as the Internet. Steps are described by which the speech signals may be encoded, and included in a document accompanied by program code to initiate actions automatically, to select segments, to decompress data, and to play sound. The documents may be web pages or electronic mail and the sounds may be helpful suggestions or advertising.

### BACKGROUND OF INVENTION

The object of the present invention is to encode speech segments in a manner in which they can be transmitted as compressed digital signals accompanying a document and decompressed and played automatically by remote computers without pre-arrangement, direct intervention or apparent delay in interactive networks such as the Internet.

Currently, speech data associated with a document is encoded in a relatively inefficient uncompressed digital format acceptable directly by most remote computers or is encoded in a streaming format that requires pre-arranged reception and/or requires the recipient at a remote computer to make one or more affirmative authorizations to initiate selection, transmission, decompression and playing.

For example, U.S. Pat. No. 5,261,027 entitled “Code excited linear prediction speech coding system” to Taniguchi et. al. shows that digital speech can be compressed. U.S. Pat. No. 5,883,891, “Method and apparatus for increased quality of voice transmission over the Internet”, to Williams et. al. shows that digitized speech can be transmitted over the Internet. U.S. Pat. No. 5,915,001, “System and method for providing and using universally accessible voice and speech data files” to Uppaluru shows that speech files can be associated with Internet documents. U.S. Pat. No. 5,991,781, “Method and apparatus for detecting and presenting client side image map attributes including sound attributes using page layout data strings” to Nielsen shows that HTML documents used in the Internet can have links to multiple speech segments. U.S. Pat. No. 6,138,089, “Apparatus system and method for speech compression and decompression” to Guberman shows that speech signals on the Internet can be highly compressed and still retain high fidelity voice quality.

One limitation of all of the above references is that a pre-arrangement must be made to convey the program instructions to decompress the sound data at the receiving computer. Further, such conveyance requires direct affirmation by the recipient.

An article by L. Richard Moore, “How Do I Create a Streaming Audio Java Applet” conveys the program instructions immediately prior to the sound data but still requires direct affirmation by the recipient. Moreover, the technique described involves time delays which would be apparent to the recipient.

A further object of the present invention is to minimize the apparent delays that currently occur in current encoding methods.

Thus, the present invention would allow, for example, sales suggestions, news releases, navigation aids, etc. to be included with documents on the Internet in a more pleasing manner without requiring authorizing mouse clicks or apparent delays.

### SUMMARY OF INVENTION

The invention covers a method of encoding documents in and interactive network such as the Internet to contain compressed, self activating, speech segments.

In operation, text and graphic documents are augmented by including: compressed speech segments, decompression code, and activation routines.

The purpose is to transmit speech segments appropriate to documents such as web-pages or e-mail messages and have the segments played without direct intervention such as viewer mouse-click or apparent transmission delay.

### BRIEF DESCRIPTION OF DRAWINGS

FIG. 1 illustrates an exemplary embodiment. An announcer (1) speaks into a microphone (2) connected to a computer (3) that digitizes, compresses, and stores the speech sounds associated with a document (4). When the document (4) is transmitted, the sending computer (3) transmits speech controlling instructions (5), decompression routines (6), and compressed speech data (7) with other text and picture elements (8) for transmission (9) to the receiving computer (10).

The receiving computer (10) receives the document (4), displays any text and picture elements, and decompresses and plays speech sounds on a speaker connected to it (11).

FIG. 1 is exemplary and not intended to limit other embodiments. For example, the computer (3) that digitizes, compresses, and stores the sound may consist of separate computers. It is also possible, and in some cases advisable, to store different portions of a document on separate computers.

FIG. 2 illustrates a document as it might appear when displayed on a computer monitor (20). The example shows text areas (21-24) and a picture area (25). In a typical remote computer, the proximity of a cursor (26) to an area, for example text area (23), can be used to signal speech controlling instructions (5) to decompress and play a portion of the compressed speech data (7) appropriate to the particular area. FIG. 2 is exemplary and not intended to portray all possible documents. Any number (including zero) of text and picture areas may be present and arranged in any fashion. Any area can be used as signal.

FIG. 3 illustrates a special embodiment in which decompression routines (35) and compressed speech data (36) are included directly in a document (30) in a character-encoded form. The document may also include control and decoding script (34) in addition to normal text (37).

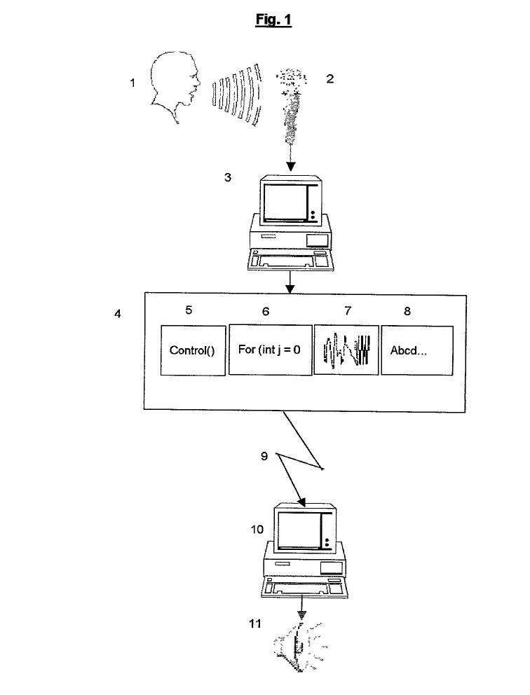

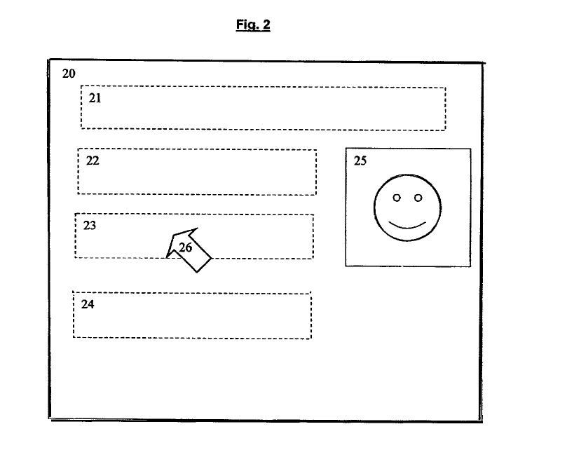

### DETAILED DESCRIPTION

Encoding and Transmitting

Digitizing and compressing speech for digital computers can be done by any of a number of techniques. For example, the microphone may be any microphone suitable for connection to audio input circuitry of a digital computer. Digital speech compression is also a well-known art and can employ the logic of any one of a number of speech compression techniques. Storage may be any convenient form of digital computer storage such as magnetic disk drives.

In the preferred embodiment sets of instructions suitable for retrieving, decompressing, and playing compressed speech data at a remote computer is also stored on a digital computer, which transmits documents to remote computers. The instructions to be executed at remote computers are written in a language directly executable by the browser or network program residing in remote computers. An example of such browsers residing in remote computers is the Internet Explorer 5 manufactured by Microsoft Corporation. An example of a language directly executable by such a browser is the Java language.

In the preferred embodiment, different sets of instructions are stored for different remote operating systems as identified within document requests, for example Windows v. Macintosh operating systems.

Because the media data is encoded at the sending computer (2) prior to transmission, the encoding program can be written without regard to programming language, program size or authorization by remote computers. Commercially available speech compression programs are suitable but it is convenient to select an encoding format that is simple to decompress.

The control routines (5) and the decompression code (6) are coded in a form executable in normally expected remote computers (7) directly within a network environment and included with the compressed media data (4) within a document (3). For example, in an Internet environment the decompression code may be a Java applet, script, or embedded commands. (Most other language formats require a prearranged download that must be authorized by the viewer at the remote computer).

The initial portion of the document (4), the speech controlling code (5), the decompression code (6), and the compressed data (7) may be transmitted by any network, for example the Internet, that connects the transmitting and receiving computers.

The order of the parts, control (5), decompression code (6), and compressed speech data (7) may be transmitted in any convenient order. In the preferred embodiment, controlling instructions are sent first, decompression code second, and speech data segments last.

In the preferred embodiment, each compressed speech data segment is sent as a separate file although groups of data segments can be combined into a file along with an index identifying the start of each segment within the file. The use of multiple files allows storage on and transmission of speech segments from different service computers on the network to help minimize delays.

The use of segmented data permits loading the bulk of the speech data while the viewer is visually scanning the text and pictures but before such segments are activated. Transmitting speech data during idle time minimizes or eliminates apparent delays and improves the viewer's enjoyment of the document.

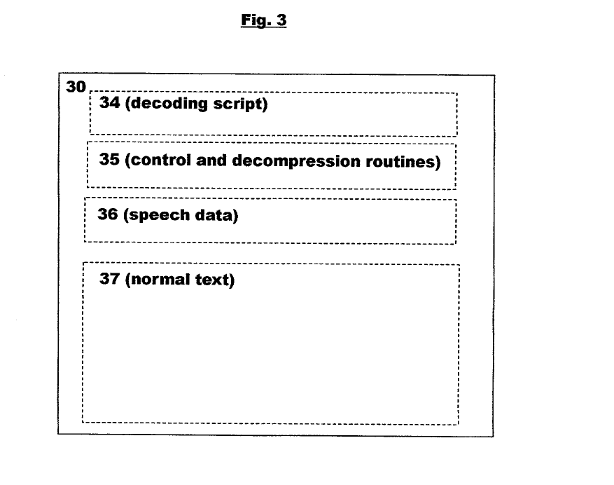

In a special embodiment, see FIG. 3 for example, the entire document is sent as a single file. In order to accomplish this all non-character, binary computer code, compressed speech segment data, and graphic images, are further encoded prior to transmission into a character form such as the known “uuencode” coding scheme and a script form of the corresponding decode routine included. This unusual arrangement allows, for example, electronic mail documents to arrive intact. Decoding, decompressing, and playing speech segments can be initiated automatically without delay when the document is selected.

Decompressing and Playing at the Remote Computer

In the preferred embodiment, the instructions controlling the receipt of speech data and activation of the decompression code are transmitted and activated with the initial portion of the document. Although several options are available to specify retrieval of the compressed speech data, the preferred embodiment retrieves the compressed speech data by executing instructions in this initial portion.

There are three advantages to this approach. First, segments known to be immediately useful, such as a welcome message, can be retrieved, decompressed, and played even before the graphic data, for example is received. Second segments containing all but the welcome speech can be retrieved with no delays apparent to a viewer because the speech data continues to be retrieved after the page appears to be complete but before the viewer activates the additional segments directly or indirectly.

In the preferred embodiment control routines decompress and play speech segments based on one or more appropriate events at the remote computer. For example, a welcome message can be initiated automatically when the document is received. Other speech segments can be initiated selectively by sensing, for example, the viewer moving the mouse over an area of the document, or after a length of time etc.

Speech segment data may be left in a compressed state until activated (preferred) or decompressed when received.

Decompression is accomplished by executing code based on the original algorithms that were used to compress the voice data. In the preferred embodiment the restored version is written as an object in a format directly playable by the browser. For example, in most computers operating under Microsoft Windows, an object in the WAV format is directly playable within most browsers.

Other Structures

It should be understood that the processes are not limited solely to the structures defined in the detailed embodiments. In particular, the network may be any network in which documents and media are transmitted including the Internet. Although general-purpose digital computers are shown, the encoding functions may be served by any special purpose circuitry. Decoding functions may be served by any special purpose circuitry where such circuitry is widely available in the receiving computers.

A special coding and decoding structure may be convenient for specific class of documents such as those transmitted as electronic mail in some cases. Typically, one use of such documents limits the bytes to be selected from a reduced set of possible characters. Binary data, such as compressed audio data can be encoded in the reduced character set by using more than one character per byte. For example, some “UUENCODE” routines code six 8-bit bytes into eight 6-bit allowable characters. In order to fully utilize this feature a self playing mail document must contain binary audio data and scripted code to decompress, and play the coded binary audio data. The advantage of this special structure is that all the data is sent at once, during, for example, a time of day when traffic is minimal. The inclusion of scripted code in the mail document to interpret the “UUENCODED” characters in the document may also be of use with other binary data such as used in transmitting pictures.

1. A method of encoding documents in an interactive network consisting of compressed speech data and the code necessary to decompress and/or play the speech without direct authorization or pre-arrangement by the viewer/listener.

2. A method in [claim 1] where the network is the Internet.

3. A method in [claim 1] in which compressed speech data is transmitted in anticipation of selection by the viewer/listener.

4. A method in [claim 1] in which compressed speech data is stored on a plurality of transmitting computers.

5. A method in [claim 1] in which media data is transmitted in character format accompanied by scripted code to restore a binary format.

6. A method of endcoding documents in an interactive network consisting of binary data transmitted in character format accompanied by scripted code to restore a binary format.

7. A method in [claim 6] where the network is the Internet.

8. A method of endcoding documents in an interactive network so as to play a speech segment based on an indirect action of the viewer of the document.

9. A method in [claim 8] where the network is the Internet
